(19) United States
(12) Patent Application Publication
(10) Pub. No.: US 2007/0272466 A1
(43) Pub. Date: Nov. 29, 2007

(54) Motorcycle with in-line radial engine

(76) Inventor: John R. Levey, Black Hawk, SD (US)

Correspondence Address: GORDON & REES LLP, 101 WEST BROADWAY, SUITE 1600, SAN DIEGO, CA, 92101, US

(21) Appl. No.: 11/805,936

(22) Filed: May 25, 2007

Related U.S. Application Data
(60) Provisional application No. 60/808,610, filed on May 26, 2006.

(51) Int. Cl. B62K 11/00

(52) U.S. Cl. 180/219

(57) ABSTRACT

A motorcycle, comprising: a frame; a front wheel connected to the frame; a back wheel connected to the frame; and a radial engine connected to the frame, wherein the radial engine is positioned in-line with the front and back wheels. The radial engine comprises a plurality of cylinders disposed in a plane passing through both the front and back wheels.

### RELATED APPLICATION

The present application claims priority to U.S. Provisional Patent Application, Ser. No. 60/808,610, entitled “Motorcycle With In-Line Radial Engine”, filed May 26, 2006, the full disclosure of which is incorporated herein in its entirety for all purposes.

### TECHNICAL FIELD

The present invention relates to motorcycles.

### BACKGROUND OF THE INVENTION

A problem common to existing two cylinder V-twin motorcycle engines is that they produce a significant amount of vibration. In addition, very large cylinders are typically used in many of these V-twin motorcycle engines to achieve a desired high power output. Unfortunately, the larger the cylinder, the greater the amount of vibration produced. Another disadvantage of using two large cylinders is that the engine often requires special starting decompression devices and very high powered starters.

It would instead be desirable to produce a motorcycle engine having high power output, but with reduced vibration.

### SUMMARY OF THE INVENTION

The present invention provides a motorcycle, having: a frame; a front wheel connected to the frame; a back wheel connected to the frame; and a radial engine connected to the frame, wherein the radial engine is positioned in-line with the front and back wheels of the motorcycle.

Preferably, the radial engine includes a plurality of cylinders disposed in a plane passing through both the front and back wheels. The radial engine preferably comprises an odd number of cylinders. In one preferred embodiment of the invention, the radial engine comprises seven cylinders; however, other numbers of cylinders are also possible within the scope of the present invention.

An advantage of the present invention is that the radial engine produces very little vibration in the frame of the motorcycle. This is due to the cylinders firing across from one another all the way around the crankshaft.

Another advantage of a radial engine is that there is no need for large counter weights to keep the engine turning smoothly.

Another advantage of the present invention is that the radial engine provides a lot of power in a comparatively small engine volume. Moreover, the present invention provides a large engine displacement in a relatively narrow cross section. Thus, the motorcycle does not become undesirably wide. Instead, the present radial engine provides only a minimal increase in frontal area, and no increase in width (as compared to a typical conventional V-twin engine).

An advantage of positioning the radial engine in line (i.e.: in the same plane) as the wheels is that the torque produced is also in-line with the motorcycle frame.

Another advantage of using several small cylinders is that they are much easier and smoother to start than the two large cylinders found in a standard V-twin motorcycle engine.

Another advantage of the present invention is that the radial engine operates with a low rpm. This makes the engine very reliable.

In preferred embodiments, the radial engine comprises a crankshaft rotating about an axis parallel to an axis of rotation of the back wheel. As such, an adapter plate can be mounted directly onto the crankshaft of the radial engine, wherein the adapter plate rotates in a plane parallel to the back wheel. This adapter plate then forms part of the drive assembly connecting the radial engine to the back wheel.

An advantage of such a drive assembly is that the rotation of the engine crankshaft is parallel to the rotation of the back wheel of the motorcycle. As such, only a simple linkage between the engine and the drive (i.e.: back) wheel of the motorcycle is needed. As a result, it is not necessary to have a complex gearing system changing the direction in which the power is taken off of the engine and sent to the back (drive) wheel.

### BRIEF DESCRIPTION OF THE DRAWINGS

FIG. 1 is a side elevation view of an embodiment of the present invention.

FIGS. 2A, 2B and 2C are respective perspective, side elevation and front elevation views of a preferred drive assembly plate.

### DETAILED DESCRIPTION OF THE DRAWINGS

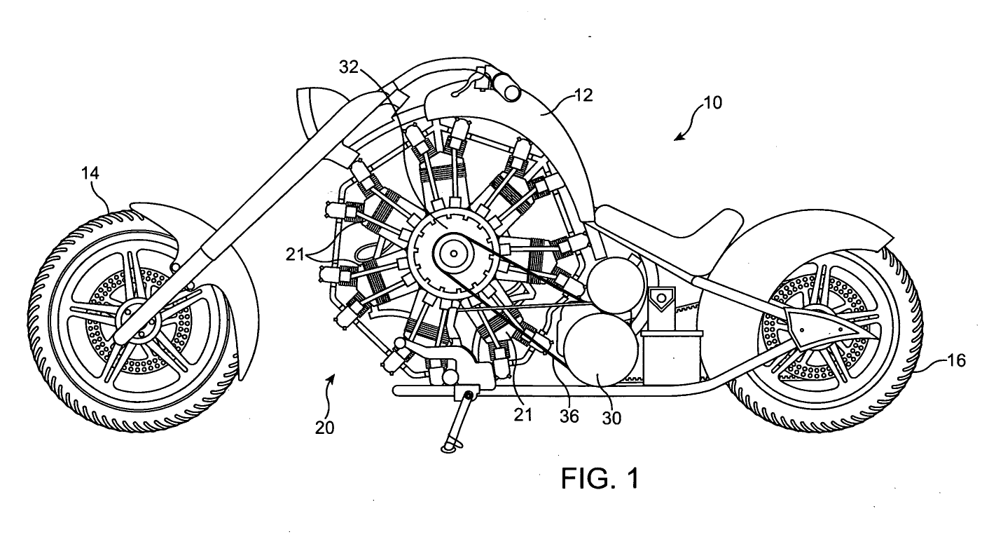

FIG. 1 is a side elevation view of an embodiment of the present invention.

As seen in FIG. 1, a motorcycle 10 is provided. Motorcycle 10 comprises: a frame 12; a front wheel 14 connected to frame 12; a back wheel 16 connected to frame 12; and a radial engine 20 connected to frame 12.

As can be seen, radial engine 20 is positioned in-line with front wheel 14 and back wheel 16. IE: radial engine 20 is positioned with each of it cylinders 21 in the same plane as wheels 14 and 16 (i.e.: as illustrated, in the plane of the paper).

Radial engine 20 comprises a plurality of cylinders 21 disposed in a plane passing through both front wheel 14 and back wheel 16 (i.e.: as illustrated, in the plane of the paper). Preferably, radial engine 20 comprises an odd number of cylinders 21. As illustrated, radial engine 20 comprises seven cylinders 21. It is to be understood, however, that the present invention is not limited to embodiments having only seven cylinders 21. Other numbers of cylinders 21 are also possible, all keeping within the scope of the present invention. Radial engine 30 preferably comprises a crankshaft rotating about an axis parallel to an axis of rotation of back wheel 16.

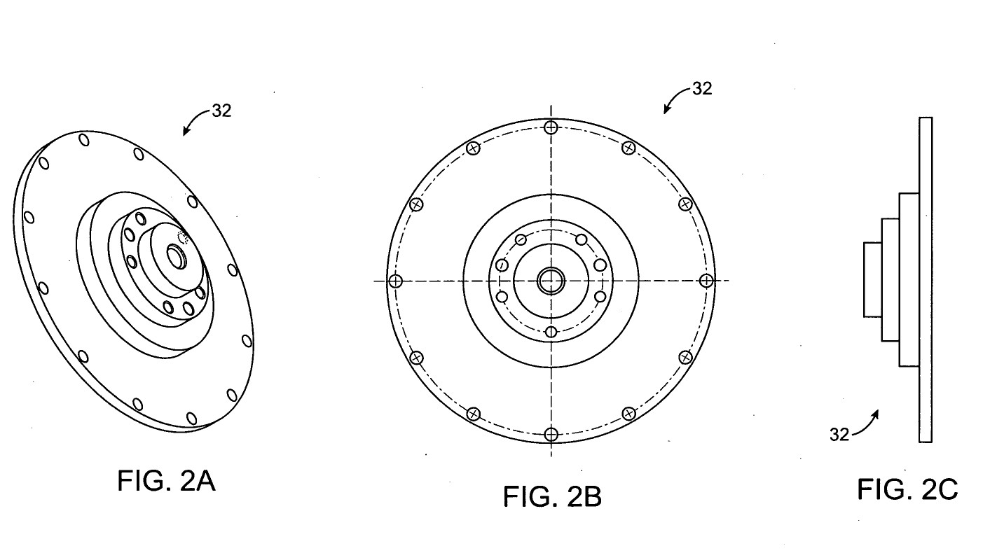

As can also be seen, motorcycle 10 further comprises a drive assembly 30 connecting radial engine 20 to back wheel 16. Drive assembly 30 preferably includes an adapter plate 32 (seen in FIGS. 2A, 2B and 2C) mounted to radial engine 20. Adapter plate 32 rotates in a plane parallel to back wheel 16. Preferably, adapter plate 32 is hidden by a guard (not shown), which prevents the user's leg from contacting drive belt 36.

What is claimed is:

1. A motorcycle, comprising:
a frame;
a front wheel connected to the frame;
a back wheel connected to the frame; and
a radial engine connected to the frame, wherein the radial engine is positioned in-line with the front and back wheels.

2. The motorcycle of claim 1, wherein the radial engine comprises a plurality of cylinders disposed in a plane passing through both the front and back wheels.

3. The motorcycle of claim 1, wherein the radial engine comprises an odd number of cylinders. s

4. The motorcycle of claim 3, wherein the radial engine comprises seven cylinders.

5. The motorcycle of claim 1, further comprising:
a drive assembly connecting the radial engine to the back wheel.

6. The motorcycle of claim 5, wherein the drive assembly comprises:
an adapter plate mounted to the radial engine, wherein the adapter plate rotates in a plane parallel to the back wheel.

7. The motorcycle of claim 1, wherein the radial engine comprises a crankshaft rotating about an axis parallel to an axis of rotation of the back wheel.
